(19) United States
(12) Patent Application Publication
(10) Pub. No.: US 2012/0248783 A1
(43) Pub. Date: Oct. 4, 2012

(54) ELECTRIC GENERATOR WITH ECONOMY MODE OPERATION

(76) Inventor: Ronald Peter Russ, Buffalo, NY (US)

(21) Appl. No.: 13/286,313

(22) Filed: Nov. 1, 2011

Related U.S. Application Data
(60) Provisional application No. 61/516,401, filed on Apr. 4, 2011.

(51) Int. Cl. H02K 7/116

(52) U.S. Cl. 290/1 C

(57) ABSTRACT

An electric generator including: a prime mover; an alternator; a first drive shaft connected to the prime mover; a second drive shaft connected to the alternator; and an overdrive assembly including: a speed conversion assembly connected to the first drive shaft; and a centrifugal clutch connected to the speed conversion assembly and to the second drive shaft. An electric generator, including: a prime mover; an alternator; and an overdrive assembly. For a load on the generator at or above a load threshold, the overdrive assembly is arranged to form a first torque path from the prime mover to the alternator, the first torque path bypassing the overdrive assembly. For a load on the generator below the load threshold, the overdrive assembly is arranged to form a second torque path from the prime mover to the alternator through the overdrive assembly.

### CROSS-REFERENCE TO RELATED APPLICATIONS

This application claims the benefit under 35 U.S.C. §119(e) of U.S. Provisional Application No. 61/516,401 filed on Apr. 4, 2011 and is incorporated herein by reference.

### FIELD OF THE INVENTION

The invention broadly relates to electric generators with a prime mover and an alternator, in particular, to an overdrive assembly enabling operation of the prime mover at lower speeds for lower electrical loads on the alternator.

### BACKGROUND OF THE INVENTION

Known electric generators use a direct drive arrangement between the engine and alternator, that is, during operation of the generator, there is no means of varying the rotational speed of the engine and the direct drive arrangement. For example, the engine must run at a specified speed, for example, 3600 RPM, at all times to provide full time, 60 Hz, A.C. power, even when demand is low. Operating at the specified speed during low demand periods results in unnecessarily high fuel usage and excessive noise.

U.S. Pat. Nos. 4,412,460 and 5,328,419 teach two-speed couplings or drives for alternators in an automobile. U.S. Pat. No. 4,412,460 teaches a centrifugal clutch with a housing directly connected to a drive shaft. The clutch engages upon a reduction of speed for the drive shaft. In general, the power for a prime mover in a portable/emergency/recreational generator is made with the lowest power output compatible with the wattage rating of the alternator for the generator. In U.S. Pat. No. 4,412,460, the power of the automobile engine is much larger than needed to operate the alternator. Thus, if the coupling configuration of U.S. Pat. No. 4,412,460 were applied to a generator, the smaller motor associated with the generator would stall under heavy load conditions for the generator. That is, U.S. Pat. No. 4,412,460 would only be usable in a generator if an enormously oversized engine were used in the generator. Every teaching in the prior art is contrary to such an engine sizing, since such an engine sizing would greatly increase the size, weight, cost, fuel consumption, and noise output of the generator and render the generator unsuitable for the intended purposes of the generator.

U.S. Pat. No. 5,328,419, as an automotive application, also has sizing and adaptation problems with respect to a portable/emergency/recreational generator. This patent uses a brake actuator assembly to engage and disengage a planetary gear set. The actuator assembly can use a vacuum motor, a solenoid, or a hydraulic cylinder. A brake band associated with the assembly also can be manually operated.

### BRIEF SUMMARY OF THE INVENTION

The present invention broadly comprises an electric generator, including: a prime mover; an alternator; a first drive shaft connected to the prime mover; a second drive shaft connected to the alternator; and an overdrive assembly including: a speed conversion assembly connected to the first drive shaft; and a centrifugal clutch connected to the speed conversion assembly and to the second drive shaft. The prime mover is arranged to provide power to the alternator via the first and second shafts.

The present invention broadly comprises an electric generator, including: a prime mover; an alternator; and an overdrive assembly. In a heavy-duty mode, in which the load on the generator is at or above a load threshold, the overdrive assembly is arranged to form a first torque path from the prime mover to the alternator, the first torque path bypassing the overdrive assembly. In an economy load mode, in which the load on the generator is below the load threshold, the overdrive assembly is arranged to form a second torque path from the prime mover to the alternator through the overdrive assembly.

The present invention broadly comprises a method of operating an electric generator, including: a prime mover; an alternator; a one-way clutch; a first drive shaft connected to the prime mover and to the one-way clutch; a second drive shaft connected to the alternator and the one-way clutch; a relay switch; and an overdrive assembly connected to the first and second drive shafts. The method includes: sensing, using the relay switch, an electrical load on the alternator; and in a first mode, for a sensed electrical load below a load threshold, transmitting first torque from the prime mover to the alternator through the first drive shaft, the overdrive assembly, and the second drive shaft. The method includes, in a second mode, for a sensed electrical load greater than or equal to the load threshold, transmitting second torque, from the prime mover to the alternator through the first and second shafts, bypassing the overdrive assembly.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic diagram of an electric generator with an overdrive assembly including a planetary gearbox and a centrifugal clutch; and,

FIG. 2 is a schematic diagram of a parallel shaft arrangement for use in place of the planetary gearbox in FIG. 1.

### DETAILED DESCRIPTION OF THE INVENTION

At the outset, it should be appreciated that like drawing numbers on different drawing views identify identical, or functionally similar, structural elements of the invention. It is to be understood that the invention as claimed is not limited to the disclosed aspects.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs.

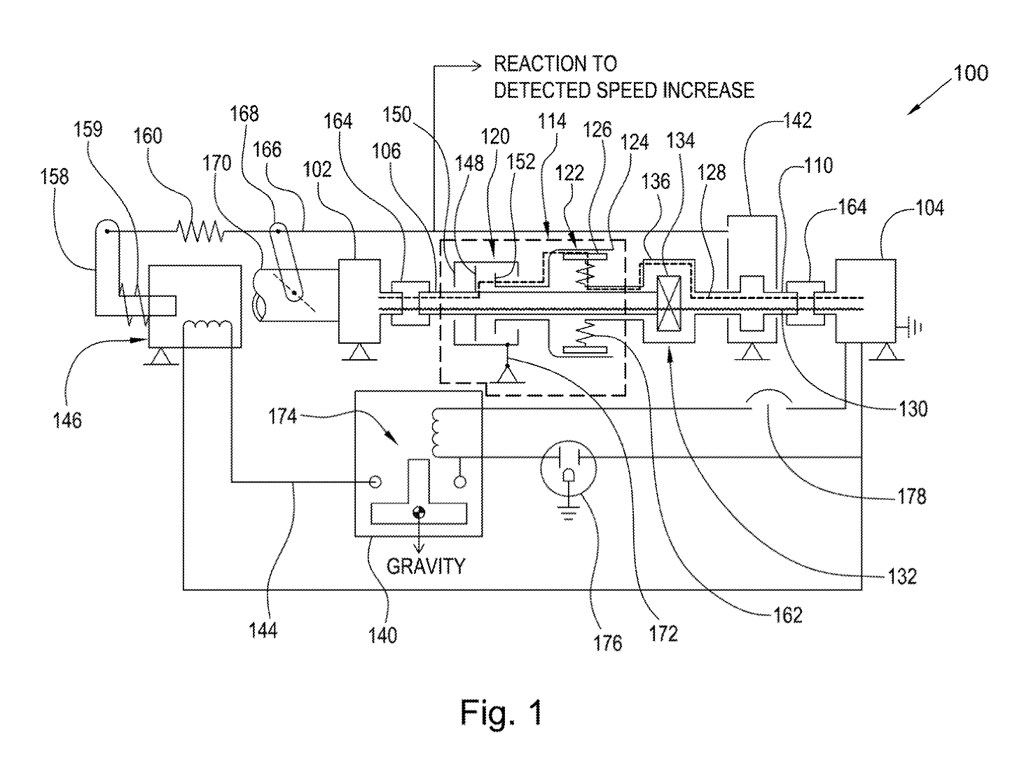

FIG. 1 is a schematic diagram of electric generator 100 with an overdrive assembly including a planetary gearbox and a centrifugal clutch.

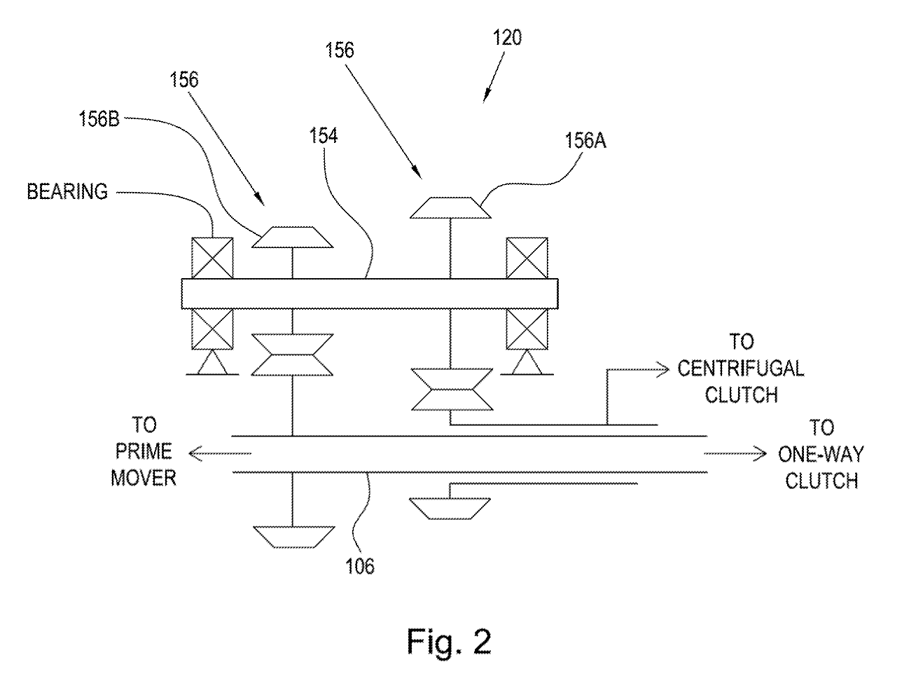

FIG. 2 is a schematic diagram of a parallel shaft arrangement for use in place of the planetary gearbox in FIG. 1. The following should be viewed in light of FIGS. 1 and 2. The generator includes prime mover 102, alternator 104, and drive shaft 106 connected to the prime mover. The prime mover is arranged to provide power to the alternator to rotate the rotor or armature of the alternator. Any prime mover known in the art can be used, for example, a gasoline or diesel fuel powered engine. Any alternator known in the art can be used. The generator also includes drive shaft 110, connected to the alternator, and overdrive assembly 114 connected to drive shaft 106 and drive shaft 110. In an example embodiment, the overdrive assembly includes speed conversion assembly 120 and centrifugal clutch 122. The centrifugal clutch is connected to the speed conversion assembly.

In an example embodiment, the centrifugal clutch includes housing 124, fixed with respect to a portion of the speed conversion assembly, and at least one friction element 126, disposed within the housing, displaceable radially outward to engage the housing, and fixed with respect to drive shaft 110. By ‘fixed with respect to’ we mean that the components in question are connected so as to rotate together. The components could be directly connected to each other or could be connected by one or more intermediate components.

In an economy mode, in which the load on the generator is less than a certain value, which can be referred to as a load threshold, the centrifugal clutch is arranged to close to connect drive shafts 106 and 110 via the speed conversion assembly. That is, torque path 128 is formed from the prime mover to the alternator through the overdrive assembly. In a heavy-duty mode, in which the load on the generator is at or above the load threshold, the centrifugal clutch is arranged to open such that drive shafts 106 and 110 are connected, bypassing the overdrive assembly. That is, torque path 130 is formed from the prime mover to the alternator without passing through the overdrive assembly.

In an example embodiment, the generator includes one-way clutch 132 including race 134 fixed with respect to drive shaft 106, and race 136 fixed with respect to drive shaft 110 and an output of the centrifugal clutch, for example, at least one friction element 126. The centrifugal clutch is arranged to close for a rotational speed of drive shaft 110 greater than a clutch threshold speed. In the heavy-duty mode, drive shaft 110 is arranged to rotate at a speed less than or equal to the clutch threshold speed, the centrifugal clutch remains open, the speed conversion assembly is disconnected from the one-way clutch, and the races of the one-way clutch are arranged to lock to rotate together. Thus, torque path 130 is formed from drive shaft 106 to drive shaft 110 via the one-way clutch. In the economy mode, drive shaft 110 is arranged to rotate at a speed greater than the clutch threshold speed, the centrifugal clutch is arranged to close, the speed conversion assembly is connected to the one-way clutch, and race 136 and shaft drive shaft 110 rotate independent of race 134. Thus, torque path 128 is formed from shaft 106 and the overdrive assembly to drive shaft 110 via the centrifugal clutch and race 136.

In an example embodiment, the generator includes relay switch 140, for sensing an electrical load on the alternator, and governor 142 arranged to control a speed of drive shaft 110 in response to an output signal, for example, on line 144, of the relay switch. For a sensed electrical load at or above the load threshold (heavy-duty mode), the relay switch is arranged to control operation of the governor such that the governor limits rotation of drive shaft 110 to a speed less than a rotation threshold speed. At the speed at or below the rotation threshold speed, the centrifugal clutch is disengaged and the prime mover and alternator are linked via torque path 130. For a sensed electrical load below the load threshold, the relay switch is arranged to control operation of the governor such that the governor controls rotation of the drive shaft 110 to a speed greater than the rotation threshold speed. At the speed above the rotation threshold speed, the centrifugal clutch is engaged and the prime mover and alternator are linked via torque path 128.

In an example embodiment, the generator includes solenoid switch 146 connected to the relay switch and the governor. For a sensed electrical load at or above the load threshold, the electric generator is arranged to operate in the heavy-duty mode and the solenoid is arranged to energize via the output signal from the relay switch to control operation of the governor. For a sensed electrical load below the load threshold, the electric generator is arranged to operate in the economy load mode and the solenoid is arranged to de-energize via the output signal of the relay switch to control operation of the governor.

In an example embodiment, the speed conversion assembly includes a planetary gearbox with ring gear 150, planet gear carrier 148, and sun gear 152. The ring gear is grounded to prevent rotation of the ring gear. The planet gear carrier is connected to drive shaft 106. The sun gear is connected to the centrifugal clutch, for example, to an input of the clutch. Thus, the planet gear carrier rotates at the speed of drive shaft 106, and the sun gear rotates at a higher speed depending on the gear ratios in the gearbox. In the economy mode, the torque in torque path 128 passes from drive shaft 106 to the centrifugal clutch via the planetary gear box.

In an example embodiment, the speed conversion assembly includes counter shaft 154, and at least one gear 156 engaged with shafts 106 and 154. Shaft 154 is mounted on bearings supported by the foundation of the generator. In general, gears 156 cause shaft 154 to rotate faster than shaft 106. The amount of the difference in rotational speeds is dependent on the gear ratios for gears 156. In the economy mode, the torque in torque path 128 passes from drive shaft 106 to the centrifugal clutch via shaft 154 and gears 156.

The following provides further detail regarding generator 100. Advantageously, generator 100 reduces the amount of fuel used by the prime mover when the generator is operating in the economy mode. For example, in the economy load, the prime mover can be operated at a lower RPM. This reduction in the speed of the prime mover is at least partly due to the overdrive assembly described above and further described below. As further described below, the overdrive assembly enables a two-speed transmission arrangement, with operation of the prime mover in one speed for the economy mode and operation of the prime mover at a higher speed for operation in the heavy-duty mode.

The following describes two exemplary scenarios with respect to operation of the generator:
1) Scenario 1: Start-up with heavy electrical load (heavy-duty mode) followed by a change to a light electrical load (economy mode); and
2) Scenario 2: Start-up in economy mode followed by a change to heavy-duty mode.

The following description includes example components and parameters for components of the generator. It should be understood that the generator is not limited to these example components and parameters and that other components and parameters are possible. In an example embodiment, the centrifugal clutch transits from disengaged at 57 Hz to fully engaged at 59 Hz. This performance characteristic enables the following:

1) 56 Hz target governed alternator speed, heavy-duty mode;

2) 57 Hz centrifugal clutch begins to engage;

3) 59 Hz centrifugal clutch fully engaged; and,

4) 60 Hz target governed alternator speed, economy mode.

The following is with respect to Scenario 1. The prime mover is started but the solenoid is initially in the un-energized state since no power is available until the alternator spools up. Since the centrifugal clutch does not engage until it is spinning at sufficient RPM, torque from the engine is transmitted along torque path 130. As the alternator speed increases, the relay switch senses the heavy electrical load and makes contact, energizing the solenoid. Solenoid plunger 158 pulls in, thus putting the alternator governor in the heavy-duty mode (56 Hz target speed). The governor maintains this speed while the heavy load exists. By holding the speed at this lower level, the centrifugal clutch is prevented from engaging so torque is transmitted along torque path 130.

When the electrical load is reduced to below the load threshold, the relay switch senses the reduction and breaks contact, de-energizing the solenoid. The solenoid plunger is pushed out by compression spring 159, thus putting the alternator governor in the economy mode (60 Hz target speed). As the alternator speed increases to 57 Hz, the centrifugal clutch begins to engage. As the clutch engages, torque from drive shaft 106, via the speed conversion assembly (spinning faster than drive shaft 106) is transmitted through the centrifugal clutch to the alternator along torque path 128. As the alternator begins spinning at the faster output of the speed conversion assembly, torque is no longer transmitted along torque path 130 but along torque path 128. When the alternator reaches the target-governed speed of 60 Hz, this speed is maintained while in economy mode. By holding the speed at this higher level, the centrifugal clutch remains fully engaged so torque is transmitted along torque path 128.

The following is with respect to Scenario 2. The engine is started and the solenoid is already in the un-energized state (economy mode). Since the centrifugal clutch does not engage until the clutch is spinning at sufficient RPM, torque from the engine is initially transmitted along torque path 130. As the alternator speed increases, the relay switch does not sense a heavy load and therefore does not make contact. The solenoid remains un-energized. As the alternator speed increases to 57 Hz, the centrifugal clutch begins to engage. As the clutch engages, torque from the speed conversion assembly (spinning faster than drive shaft 106) is transmitted through the centrifugal clutch to the alternator. As the alternator begins spinning at the faster output of the speed conversion assembly, torque is no longer transmitted along torque path 130 but along torque path 128. When the alternator reaches the target-governed speed of 60 Hz, this speed is maintained while in economy mode. By holding the speed at this higher level, the centrifugal clutch remains fully engaged so torque is transmitted along torque path 128.

When the electrical load is increased to at or above the load threshold (heavy-duty mode), the electrical relay switch senses the increase and makes contact, energizing the solenoid and pulling in the plunger. This sequence puts the alternator governor in the heavy-duty mode (56 Hz target speed). As the alternator speed decreases to 57 Hz, the centrifugal clutch begins to disengage. As the clutch disengages, torque is no longer transmitted along torque path 128, but along torque path 130. When the alternator reaches the target-governed speed of 56 Hz, this speed is maintained while in the heavy-duty mode. By holding the speed at this lower level, the centrifugal clutch remains fully disengaged so torque is transmitted along torque path 130.

The following provides further exemplary details regarding components of generator 100. It should be understood that the generator is not limited to these details:
1) Centrifugal clutch: The engagement RPM is determined by the spring rate (stiffness) of internal springs 162; therefore, the engagement RPM can be adjusted by using springs with different spring rates.
2) One-way clutch: Roller/wedge or sprag types can be used.
3) Planetary gearbox: To accommodate a 1500 RPM engine idle and a 3600 RPM (60 Hz) alternator input, the gear ratio is 2.4:1 (3600:1500). This ratio can be accomplished with a planetary gearbox having the ring gear stationary, input to the planet gear carrier, and output from the sun gear. The number of gear teeth is in a ratio of 7:5:1 for the ring, sun, and planet gears respectively, since the gearbox ratio=1+(number of ring gear teeth/number of sun gear teeth). The addition of a hunting tooth can reduce wear problems. Torque arm mounting of the planetary gearbox avoids unnecessary bearing loading from misalignment.
4) Double reduction parallel shaft arrangement (gears 156 and shafts 106 and 154): The gear teeth ratio would be 1.55:1. The overall ratio would then be the desired 2.4:1=(1.55)(1.55):1.
5) Relay switch: Can be an electrical magnetic coil style relay. Other types, such as solid state or Hall effect current sensors with built-in integrated circuits, can be used.
6) Solenoid: For a prime mover including a gasoline engine, the solenoid can be mounted near the engine carburetor throttle shaft where a light tension spring, such as spring 160, attached to the plunger end can counterbalance the force of the governor link. Spring 159 is sized to allow the plunger to pull in all the way when energized and push out all the way when de-energized. The solenoid voltage can be selected to match the voltage present at the relay switch.
7) Alternator speed governor: a pneumatic type is cost-effective. A centrifugal governor with flyweight mechanism can be used for more precise speed control.
8) Drive shaft 106: Solid steel shaft. For a speed conversion assembly including a planetary gearbox, shaft 106 passes through the center of the planetary gearbox and the center of the centrifugal clutch (without affecting the rotation of the shaft) to deliver torque from the engine to the one-way clutch. The centrifugal clutch, one-way clutch, planetary gearbox, governor, and drive shaft 106 can be integrated into a single unit.

The following are further considerations regarding generator 100. The heavy-duty frequency of 56 Hz used as an example could be adequate for most household purposes since induction and universal motors, televisions, radios and even desktop computers are all rated at 50-60 Hz. Should the RPM span for the centrifugal clutch engagement be greater than the 57 Hz to 59 Hz (3420-3540 RPM) of the above example, for example, 51 Hz to 59 Hz (3060-3540 RPM), the heavy-duty frequency would still meet the 50 Hz minimum requirement. System stability is enhanced by the difference between the centrifugal clutch disengagement threshold (57 Hz) and the target alternator heavy-duty frequency (56 Hz) as well as the difference between the target alternator light load frequency (60 Hz) and the centrifugal clutch full engagement point (59 Hz). Stability increases with an increase in either frequency difference.

An electrical magnetic coil style relay also has a performance characteristic that adds to system stability. For example, the pick-up current is the threshold to make contact, exceeding the drop-out current, which is the threshold to break contact. Since less current is required for the magnetic coil to hold the contact core than pull it up to create contact in the first place, there is no possibility of an electrical load equal to one of the thresholds causing an unwanted cycling between the heavy-duty and economy relay positions.

In an example embodiment, generator 100 also includes shaft couplers 164, governor linkage 166, throttle shaft lever 168, carburetor throttle 170, torque arm 172, relay contact core 174, outlet socket 176, circuit breaker 178, large diameter gear 156A, and small diameter gear 156B.

Generator 100 has at least the following advantages:
1) By reducing prime mover speed under light electrical load (economy mode), fuel economy is increased and noise is reduced.
2) In an example embodiment, a solid connection between shaft 110 and the conventional input of the centrifugal clutch elements 126, rather than with housing 124.
3) In an example embodiment, the governor senses rotary speed at the alternator input rather than at the conventional prime mover location. However, the same reliable linkage to the carburetor throttle shaft lever and opposing light tension spring can be used.
4) Provides for downshifting out of overdrive under heavy electrical load. This is important in a portable/emergency/recreational generator application because the engine, such as prime mover 102, is sized near its maximum horsepower output at the peak alternator wattage rating, which requires the direct drive mode as shown by torque path 130. The engine sizing is done at least to minimize and optimize the size, weight, fuel consumption, and noise output of the generator, while reducing the cost of the generator. At the lower engine speeds associated with overdrive and a heavy electrical load on the alternator, the engine would stall out if left in the overdrive mode (torque path 128).

In an example embodiment (not shown), the centrifugal clutch is replaced by an electromagnetic clutch, enabling direct control of the shifting between modes by the electrical relay switch without the dual alternator speed arrangement. The alternator could then be governed at 60 Hz for both heavy and light electrical loads. In an example embodiment (not shown), the centrifugal clutch is replaced with a solenoid actuated brake on the ring gear of the planetary gearbox. In this embodiment, torque arm mounting 172 is eliminated. The solenoid/relay wiring is unchanged. The solenoid tightens the brake when energized and is released by the compression spring. The relay is modified so the contacts are normally closed, and only open for high current. The dual alternator speed arrangement also is eliminated and the alternator is governed at 60 Hz for both heavy and light electrical loads. An alternator speed sensor relay in sequence with the solenoid could prevent unwanted overdrive actuation during spool up to 60 Hz. A spring cushioned coupler at the engine input could relieve stress on the gear set from the abrupt solenoid/brake actuation.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. An electric generator, comprising:
a prime mover;
an alternator;
a first drive shaft connected to the prime mover;
a second drive shaft connected to the alternator; and,
an overdrive assembly including:
a speed conversion assembly connected to the first drive shaft; and,
a centrifugal clutch connected to the speed conversion assembly and to the second drive shaft, wherein the prime mover is arranged to provide power to the alternator via the first and second shafts.

2. The electric generator of claim 1, wherein the centrifugal clutch includes:
a housing fixed with respect to the speed conversion assembly; and,
at least one friction element disposed within the housing, displaceable radially outward to engage the housing, and fixed with respect to the second drive shaft.

3. The electric generator of claim 1, wherein:
in an economy mode, in which the load on the generator is below a load threshold, the centrifugal clutch is arranged to close to connect the first drive shaft to the second drive shaft via the overdrive assembly; and,
in a heavy-duty mode, in which the load on the generator is at or above the load threshold, the centrifugal clutch is arranged to open such that the first drive shaft is connected to the second drive shaft, bypassing the overdrive assembly.

4. The electric generator of claim 1 further comprising a one-way clutch including:
a first race fixed with respect to the first drive shaft; and,
a second race fixed with respect to the centrifugal clutch and the second drive shaft, wherein:
the centrifugal clutch is arranged to close for a rotational speed of the second drive shaft greater than a clutch threshold speed;
in a heavy-duty mode, in which a load on the generator is at or above the load threshold, the second drive shaft is arranged to rotate at a speed less than or equal to the clutch threshold speed, and the first and second races are arranged to lock to rotate together; and,
in an economy mode, in which the load on the generator is below a load threshold, the second drive shaft is arranged to rotate at a speed greater than the clutch threshold speed, and the second race is arranged to rotate independent of the first race.

5. The electric generator of claim 1 further comprising:
a relay switch for sensing an electrical load on the alternator; and,
a governor arranged to control a speed of the second drive shaft in response to an output signal from the relay switch, wherein:
for a sensed electrical load above a load threshold, the relay switch is arranged to control operation of the governor such that the governor limits rotation of the second drive shaft to a speed less than a rotation threshold speed; and,
for a sensed electrical load below the load threshold, the relay switch is arranged to control operation of the governor such that the governor limits rotation of the second drive shaft to a speed greater than the rotation threshold speed.

6. The electric generator of claim 5 further comprising a solenoid switch connected to the relay switch and the governor, wherein:
for a sensed electrical load at or above the load threshold, the solenoid is arranged to energize via the output signal of the relay switch to control operation of the governor; and,
for a sensed electrical load below the load threshold, the solenoid is arranged to de-energize via the output signal of the relay switch to control operation of the governor.

7. The electric generator of claim 1, wherein the speed conversion assembly includes a planetary gearbox with:
a ring gear grounded to prevent rotation of the ring gear;
a planet gear carrier connected to the first drive shaft; and,
a sun gear connected to the centrifugal clutch.

8. The electric generator of claim 1, wherein the speed conversion assembly includes:
a third shaft; and,
a plurality of gears engaged with the first, second, and third shafts.

9. An electric generator, comprising:
a prime mover;
an alternator; and,
an overdrive assembly, wherein:
in a heavy-duty mode, in which a load on the generator is at or above the load threshold, the overdrive assembly is arranged to form a first torque path from the prime mover to the alternator, the first torque path by-passing the overdrive assembly; and,
in an economy load mode, in which the load on the generator is below a load threshold, the overdrive assembly is arranged to form a second torque path from the prime mover to the alternator through the overdrive assembly.

10. The electric generator of claim 9 further comprising:
a first drive shaft connected to the prime mover; and,
a second drive shaft connected to the alternator, wherein
the overdrive assembly is arranged to receive torque from the first drive shaft; and,
the overdrive assembly is arranged to transmit torque to the second drive shaft.

11. The electric generator of claim 9 wherein the overdrive assembly includes:
a centrifugal clutch arranged to transmit torque in the economy mode; and,
a speed conversion assembly arranged to receive torque from the first drive shaft.

12. The electric generator of claim 11, wherein:
in the economy mode, the centrifugal clutch is arranged to close to form the first torque path from the first drive shaft to the second drive shaft via the speed conversion assembly; and,
in the heavy-duty mode, the centrifugal clutch is arranged to open to form the second torque path through the first and second drive shafts, bypassing the overdrive assembly.

13. The electric generator of claim 11 further comprising a one-way clutch with:
a first race fixed to the first drive shaft; and,
a second race fixed to the centrifugal clutch and to the second drive shaft, wherein:
the centrifugal clutch is arranged to close for a rotational speed of the second drive shaft greater than a clutch threshold speed;
in the heavy-duty mode, the second drive shaft is arranged to rotate at a speed less than or equal to the clutch threshold speed, and the first and second races are arranged to lock to rotate together; and,
in the economy mode, the second drive shaft is arranged to rotate at a speed greater than the clutch threshold speed, and the second race is arranged to rotate independent of the first race.

14. The electric generator of claim 10 further comprising:
a relay switch for sensing an electrical load on the alternator; and,
a governor arranged to control a speed of the second drive shaft in response to an output signal from the relay switch, wherein:
for a sensed electrical load at or above the load threshold, the relay switch is arranged to control operation of the governor such that the governor limits rotation of the second drive shaft to a speed less than a rotation threshold speed; and,
for a sensed electrical load below the load threshold, the relay switch is arranged to control operation of the governor such that the governor controls rotation of the second drive shaft to a speed greater than the rotation threshold speed.

15. The electric generator of claim 14 further comprising a solenoid switch connected to the relay switch and the governor, wherein:
for a sensed electrical load above the load threshold, the electric generator is arranged to operate in a heavy-duty mode and the solenoid is arranged to be energized via the output signal of the relay switch to control operation of the governor; and,
for a sensed electrical load below the load threshold, the electric generator is arranged to operate in an economy load mode and the solenoid is arranged to be de-energized via the output signal of the relay switch to control operation of the governor.

16. The electric generator of claim 11, wherein the speed conversion assembly includes a planetary gearbox with:
a ring gear grounded to prevent rotation of the ring gear;
a planet gear carrier connected to the first drive shaft; and,
a sun gear connected to the centrifugal clutch.

17. The electric generator of claim 11, wherein the speed conversion assembly includes:
a third shaft; and,
a plurality of gears engaged with the first, second, and third shafts.

18. A method of operating an electric generator, including: a prime mover; an alternator; a one-way clutch; a first drive shaft connected to the prime mover and to the one-way clutch; a second drive shaft connected to the alternator and the one-way clutch; a relay switch; and an overdrive assembly connected to the first and second drive shafts, the method comprising:
sensing, using the relay switch, an electrical load on the alternator;
in a first mode, for a sensed electrical load below a load threshold, transmitting first torque from the prime mover to the alternator through the first drive shaft, the overdrive assembly, and the second drive shaft; and,
in a second mode, for a sensed electrical load greater than or equal to the load threshold, transmitting second torque, from the prime mover to the alternator through the first and second shafts, bypassing the overdrive assembly.

19. The method of claim 18 wherein:
the overdrive assembly includes:
a centrifugal clutch; and,
a speed conversion assembly; and,
the one-way clutch includes:
a first race connected to the first drive shaft; and,
a second race connected to the overdrive assembly and the second drive shaft, the method further comprising:
in the first mode:
rotating the second shaft at a speed greater than a clutch threshold speed;
closing the centrifugal clutch to connect the first drive shaft to the one-way clutch via the speed conversion assembly; and,
rotating the second race independent of the rotation of the first race; and,
in the second mode:
rotating the second shaft at a speed less than or equal to the clutch threshold speed;
opening the centrifugal clutch to disconnect the overdrive assembly from the second drive shaft; and,
rotating the first and second races at a same speed.

20. The method of claim 18 wherein the generator includes a governor, the method further comprising:
in the first mode, operating, in response to an output signal from the relay switch and using the governor, the second drive shaft at a speed greater than a rotation threshold speed; and,
in the second mode, operating, in response to the output signal from the relay switch and using the governor, the second drive shaft at a speed less than or equal to the rotation threshold speed.
